(19) United States
(12) Patent Application Publication
(10) Pub. No.: US 2026/0355744 A1
(43) Pub. Date: Nov. 12, 2026

(54) MICROFLUIDIC SYSTEM

(71) Applicant: INOREVIA, Saint-Germain-En-Laye (FR)

(72) Inventors: David Gosselin, Cachan (FR); Julien Autebert, Le Kremlin-Bicetre (FR)

(21) Appl. No.: 19/477,067

(22) PCT Filed: Apr. 19, 2024
(86) PCT No.: PCT/EP2024/060794

§ 371 Date: Oct. 20, 2025

(30) Foreign Application Priority Data
Apr. 21, 2023 (EP) 23169296.3

(51) Int. Cl. B01L 3/00

(52) U.S. Cl. CPC B01L 3/502761

(57) ABSTRACT

The invention relates to a microfluidic system (1000) comprising a microchannel (21), a pump (30) connected to the microchannel (21) and configured for driving a fluid comprising magnetic particles (31) alongside said microchannel (21), at least one capture device (100) comprising a magnetic element (101) configured to produce a magnetic field with a fixed range of action, said magnetic element (101) comprising a magnetizable tip (11) and a magnet (12), at least one actuator (50a, 50b) configured for moving the magnetic element (101) relative to the microchannel (21), the capture device (100) being configured to adopt two positions: a first position wherein the microchannel (21) is comprised in the range of action of the magnetic field and the magnetic particles (31) are captured and a second position wherein the microchannel (21) is outside of the range of action of the magnetic field and the magnetic particles (31) are free.

### FIELD OF INVENTION

The present invention relates to microfluidic systems and methods, in particular, intended to magnetically manipulate magnetic particles and their applications in detection and/or quantification of analytes.

### BACKGROUND OF INVENTION

Magnetic particles or beads is a class of nanoparticle whose movements can be manipulated using magnetic fields. A wide variety of potential applications have been envisaged including next-generation sequencing (NGS), polymerase chain reaction (PCR), quantitative PCR (qPCR), droplet digital PCR (ddPCR), protein purification, or immunoassay.

For instance, immunoassay is a powerful technique extensively used in clinical research and medical diagnosis for diseases biomarker screening. Its remarkable specificity and sensitivity is due to the molecular recognition between an antibodies and its target among a huge range of material in a sample. Most of assays are heterogeneous: the immunologic complex is created onto a solid surface, typically the bottom of micro-titer plate, and unbound molecules are removed by several washing step before detection. However, this format presents several drawbacks in which the low capture area and surface-to-volume ratio are the most crucial because they are directly related to the immunoassay sensitivity.

The apparition of magnetic particles as solid support to perform biomarkers capture enables to overcome those issues. Indeed, magnetic particles show a large specific surface with an important binding capacity giving a better capture efficiency. Moreover, thanks to their super paramagnetic property, they are easy to handle, which makes the numerous immunoassay separation and washing steps faster to perform. The coupling of the large capture area combined with a microfluidic format enables to achieve point-of-care platforms for detecting biomarkers in a few minutes with a good sensitivity.

To manipulated the magnetic particles, it is known to use devices capable of exerting and measuring forces on the magnetic particles using a magnetic field gradient.

A common setup consists of an electromagnet associated with a tip-shaped end. This results in an activable high field gradient around the tip. Any paramagnetic material within that gradient is magnetized and pulled towards the tip. The force magnitude depends on the magnitude and gradient of the magnetic field. While the magnitude can be controlled by the current that drives the electromagnet, the gradient depends on the distance between the tip and the electromagnet.

However, controlling the magnetic field to obtain a desired magnitude and gradient is very sensitive and energy-consuming. Moreover, it has been observed that this solution causes issues with the magnetic particles manipulation, such as difficulties to capture the entirety of the magnetic particles and distortion or breaks-up of the droplets in which the magnetic particles are encapsulated.

Therefore, the problem solved by the invention is to obtain a system with an improved manipulation of the magnetic particles for performing chemical, biological, physical or biochemical processes, analysis or reactions.

### SUMMARY

This invention thus relates to a microfluidic system comprising:
at least one microchannel,
a pump connected to the at least one microchannel and configured for driving at least one fluid comprising at least one magnetic particle alongside said microchannel,
at least one capture device comprising:
   a magnetic element configured to produce a magnetic field with a fixed range of action, said magnetic element comprising a magnetizable tip and a magnet, wherein the magnetizable tip comprises a soft magnetic material and the magnet is a permanent magnet configured to generate a persistent magnetic field
   at least one actuator configured for moving together the magnetizable tip and the magnet of the magnetic element relative to the microchannel,
the capture device being configured to adopt two positions:
   a first position wherein the tip is close to the microchannel, said microchannel being comprised in the range of action of the magnetic field of the magnetic element, the capture device being configured to apply the magnetic field to the at least one magnetic particle present in the at least one microchannel to capture the at least one magnetic particle, and
   a second position wherein the tip is distant from the at least one microchannel, said microchannel being outside of the range of action of the magnetic field of the magnetic element, so that the at least one magnetic particle present in the microchannel are free to move in the at least one fluid.

By “outside of the range of action”, it is meant a distance sufficient to decrease the magnetic field and the magnetic field gradient, to a value in which it is no more able to displace said magnetic particles in a time compatible with the experiments. In practice, this will correspond for instance to situations in which the distance between the magnetic tip and the micro channel is larger that at least 10 times, or preferably 20 times, or even 50 times the lateral dimension or a radius of said microchannel. In some other embodiments, this may also correspond to situations in which the distance between the magnetic tip and the micro channel is larger that at least 10 times, or preferably 20 times, or even 50 times a radius of the tip.

In other words, the invention relates to a microfluidic system wherein a magnetic element is used to capture the magnetic particles and wherein the magnetic element is made of two parts: a magnet capable of generating a magnetic field and a magnetizable tip. The magnetizable tip can generate a magnetic field induced by its close proximity with the magnet. Therefore, the invention relies in putting in close contact the magnet and the magnetizable tip to obtain a precision tool capable of selectively capturing magnetic particles without perturbating the rest of the system. The invention also relies on the fact that the magnet and the tip are moved together as a whole using the at least one actuator. This allows to obtain an improved manipulation of the magnetic particles by reducing the risks of distortion or breaks-up of the droplets.

The magnetizable tip comprises a soft magnetic material and the magnet is a permanent magnet configured to generate a persistent magnetic field and since they are in direct and permanent contact and moved together, the magnetic element generates a controlled magnetic field without disturbance. The magnetic particles can then be controlled in an efficient and reliable manner since they can be efficiently brought together when the magnetic element is moved towards the microfluidic microchannel, and reliably released when the magnetic element is moved away from the microfluidic microchannel.

Therefore, the magnetic element does not require a power source to generate the magnetic field. The magnetic field applied onto the microchannel is regulated only by approaching or withdrawing the magnetic element, which is a mechanically simple way of controlling the magnetic field, compared to solutions that use an activable magnetic element such as an electromagnet, which requires to precisely control the input current to obtain the desired gradient and magnetic field.

According to an embodiment, the at least one actuator is configured to move the magnetic element relative to the microchannel using a translation motion transversal to an axis of the at least one microchannel. In some other preferred embodiments, however, the motion can be a rotational motion. Preferably, this rotation is not in a plane encompassing the microchannel

A transversal motion is a 1D movement that is very easy to implement in microfluidic systems. Simple and economic devices may be used such as screw-based devices or hydraulic-based devices.

According to a preferred embodiment, the at least one actuator comprises a housing and a piston rod inside the housing, said piston rod being configured to be moved along a length of the housing, and wherein the magnetic element is attached to the piston rod.

In practice, the magnet comprises a first surface and a second surface opposed to the first surface, the first surface being attached to the piston rod and the second surface being attached to an attachment surface of the magnetizable tip. A contour of the second surface of the magnet is, preferably, at least as large as a contour of the attachment surface of the magnetizable tip.

Advantageously, the system comprises two parallel actuators including a first actuator and a second actuator, the magnetic element being attached to a first piston rod of the first actuator and to a second piston rod of the second actuator. The two actuators allow to stabilize the capture device, while providing more flexibility and control over the position of the magnetizable tip.

As explained before, the capture device is configured to adopt at least two positions. According to an embodiment, in the first position, the tip is in contact with the at least one microchannel. Indeed, the closest from the microchannel wall the tip is, the more efficient the magnetic particles capture is.

It is also an objective of the invention that the magnetic field generated at the magnetizable tip has a value comprised between 100 mT and 10000 mT and a gradient comprised between 100 T/m and 10000 T/m. Such values may be optimized depending on the type of fluid, the nature of the biological target to capture and the type of magnetic particle.

Therefore, based on these values, in the second position, the tip is located within a distance comprised between 5.5 mm and 7 mm from the at least one microchannel, preferably between 6 mm and 6.4 mm. At the second position, the magnetic particles are free to move and interference with the microfluidic flow is minimized.

According to an embodiment, the at least one actuator is configured to move the magnetic element at a speed comprised between 1 mm/s and 20 mm/s, preferably between 2 mm/s and 10 mm/s, and yet preferably between 4 mm/s and 5 mm/s, preferably comprised between 4.5 mm/s and 5 mm/s. The speed of the actuator for moving the magnetic element can be optimized depending on the specific application and depending on the microfluidic environment. The speed is advantageously adapted to allow a precise positioning of the tip with respect to the microchannel wall. Indeed, if the tip is too far away from the microchannel, the magnetic field is not strong enough to precisely capture the magnetic particles and if the tip is too close the microchannel, it can damage the microchannel and even compromise its integrity by puncturing it.

According to another aspect, the invention relates to a method of extracting at least one magnetic particle from at least one droplet of a fluid flowing in at least one microchannel. The method uses a system such as described above and comprises the step of:
pumping inside said microchannel the at least one fluid comprising at least one magnetic particle, and
switching the capture device to the first position and capturing the at least one magnetic particle.

According to an embodiment, the method further comprises:
pumping inside said microchannel a first fluid,
pumping inside said microchannel at least one droplet of a second fluid, said second fluid being immiscible with the first fluid, said second fluid comprising the at least one magnetic particle,
switching the capture device to the first position and capturing the at least one magnetic particle present in the at least one droplet of second fluid, and pumping outside said microchannel the at least one droplet of the second fluid.

Such method allows to create droplets in which the magnetic particles are encapsulated and to manipulate the droplets using the pumping means to proceed with biological or chemical protocols such as purification or extraction of biological matter such as proteins, DNA, RNA, antibodies and the like.

### BRIEF DESCRIPTION OF THE DRAWINGS

The invention will be better understood, and other aims, details, characteristics advantages thereof will emerge more clearly on reading the detailed explanatory description which follows, of embodiments of the invention given by way of illustration, purely illustrative and non-limiting examples, with reference to the accompanying drawings:

FIG. 1 is a perspective schematic view of a system according to a first embodiment of the invention,

FIG. 2 is a perspective schematic view of a system according to a second embodiment of the invention,

FIG. 3 is a perspective view of the capture device from FIG. 1 or 2,

FIG. 4 is block-diagram of the method according to the invention,

FIG. 5 is a schematic view of a first step of the method from FIG. 4,

FIG. 6 is a schematic view of a second step of the method from FIG. 4,

FIG. 7 is a schematic view of a third step of the method from FIG. 4,

FIG. 8 is a schematic view of a fourth step of the method from FIG. 4, and

FIG. 9 is a schematic view of a fifth step of the method from FIG. 4.

### DETAILED DESCRIPTION

### Microfluidic System 1000

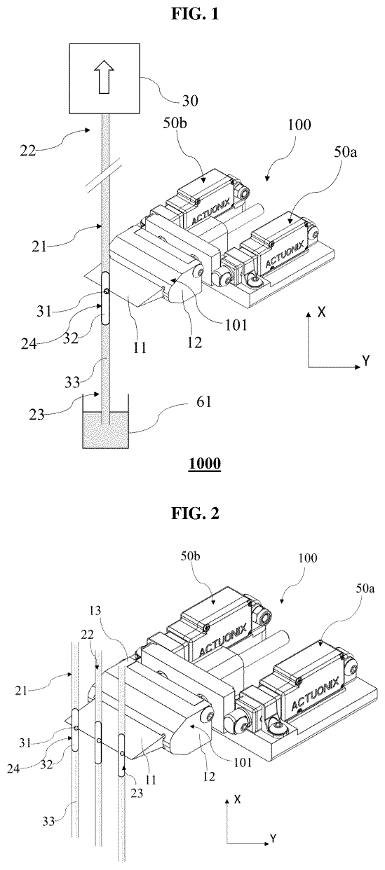

FIG. 1 shows a microfluidic system 1000 comprising at least one micro channel 21 extending along a longitudinal axis X. The at least one micro channel 21 comprises an upper end 22 and a lower end 23. The upper end 22 is connected to pumping means 30 configured for driving, alongside the microchannel 21, fluids 32, 33 comprised in reservoirs 61. At least one of these fluids 32, 33 comprises at least one magnetic particle 31. Alternatively, the pumping means 30 may be connected to the lower end 23 of the microchannel 21. The microfluidic system 1000 also comprises at least one capture device 100 for generating a magnetic field to capture the magnetic particles 31 present inside the micro channel 21 and perform a method according to the invention, for example as illustrated on FIGS. 4 to 9.

Advantageously, the microfluidic system 1000 may comprise at least one pair of capture devices 100 facing each other on both sides of the at least one micro channel 21 and extending along an axis Y that is transverse to the axis X, preferably perpendicular to the axis X. The pair of capture devices 100 may also be referred to as “magnetic tweezers”. This can be done to increase the magnetic field intensity and thus to facilitate even more magnetic particles 31 manipulations.

### Capture Device 100

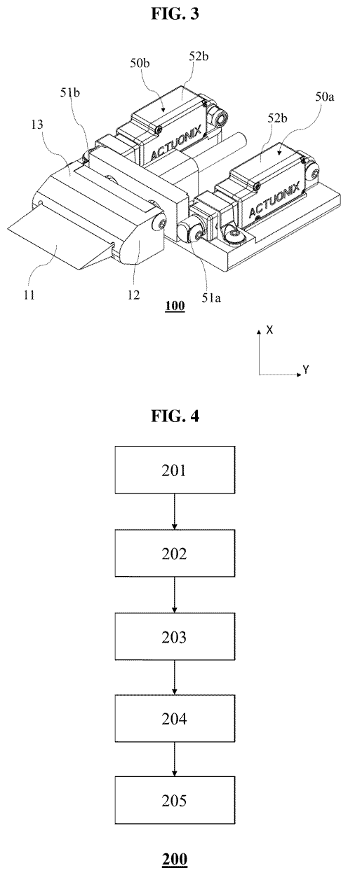

As illustrated in FIG. 3, the capture device 100 comprises a magnetic element 101 mounted on at least one actuator 50a, 50b.

### Magnetic Element 101

As illustrated in FIG. 3, the magnetic element 101 comprises a housing 13 configured to encapsulate a permanent magnet 12 and to maintain together the permanent magnet 12 and a tip 11. The permanent magnet 12 may have parallelepiped shape with a height comprised between 0.5 cm and 1 cm, typically 0.8 cm, a length comprised between 0.5 cm and 10 cm, typically 4 cm and a width comprised between 0.1 cm and 1 cm, typically 0.15 cm. The permanent magnet 12 may be made of neodymium-iron-boron (NdFeB) or samarium-cobalt (SmCo), with additionally a coating of nickelage (Ni—Cu—Ni). The permanent magnet 12 may be classified as N52, meaning that it resists to a temperature up to 80 °C without loosing its magnetic properties and a remanence comprised between 1420 mT and 1470 mT.

The housing 13 may be made of a rigid material such as plastics, ceramics, titanium, aluminum or stainless steel. Alternatively, the housing 13 may be made of an elastic material such as rubber. The permanent magnet 12 and the tip 11 may be inserted into the housing 13 by deforming the elastic material. The housing 13 may be adapted to the permanent magnet 12 shape and to the tip 11 shape using adjustment means such as screws. The permanent magnet 12 and the tip 11 may additionally be maintained together using fixing means such as a glue or a weld. Alternatively, the magnet 12 may be an activable magnet such as an electromagnet. The magnet may have a thickness comprised between 2 mm to 20 mm, preferably 2 mm to 15 mm, more preferably 2 mm to 10 mm and more preferably 5 mm to 10 mm.

The tip 11 may have several shapes. It may take the shape of a cone with a circular section. Conical tips 11 according to the invention preferably have a half angle at summit smaller than 45°, preferably smaller than 30°, more preferably smaller than 25° or alternatively smaller than 20°. Another type of tip 11 particularly useful in the invention, is a blade-shaped tip 11. In that case, the tip 11 may have an acute tip angle in one direction only, i.e. in a plane perpendicular to the edge of the blade. Blade-like tips 11 according to the invention preferably have a tip angle smaller than 45°, preferably smaller than 30°, more preferably smaller than 25° or alternatively smaller than 20°. Blade-like tips have the advantage of enabling to target multiple microchannels in the same time.

Another type of tip 11 particularly useful in the invention, is a tip 11 with a triangular prism shape including a rectangular base and an elongated opposite edge such as illustrated in FIG. 3. However, tips 11 according to the invention may have many different shapes. For instance, the three-dimensional shape of the tip 11 may have more complex shapes involving ellipsoids, rounded blades and the like. Also, for reasons of mechanical fabrication or solidity, tips 11 according to the invention may be blunt of flat at its very end. Overall, it is advantageous that the tip 11 has a generally decreasing section. The flat or blunt part may only represent a small area as compared to the largest section of the tip 11, typically smaller than 10% of said largest section, preferably less than 5% of said largest section, and more preferably less than 2% of said largest section.

The typical dimensions of the tip 11 may vary depending on the applications, and notably on the size of the microchannel 21. The tip 11 may have an overall length at least equal or superior to the magnet thickness, more preferably a length up to 2 times greater, more preferably up to 3 times greater, and advantageously up to 4 times greater than magnet thickness. The tip 11 of the magnetic element 101 may have dimensions comparable with the dimensions of the microchannel 21. For instance, a length of the tip 11 may be defined as the distance between the upper point of the tip 11 and the permanent magnet 12. For instance, for a microchannel 21 of lateral size comprised between 100 μm and 1 mm, the tip 11 may have a length comprised between 500 μm and 20 mm or between 200 μm and 10 mm.

The tip 11 is preferably made out of a soft magnetic material such as a metal, metal alloys such as iron-silicon alloys, nickel-iron alloys, iron-cobalt alloys, ferrites and the like, so as to exhibit no or little remanent magnetism after excitation. Those materials have the advantages of being adapted to multiple different tip forms and provide a greater ranger of manufacturability compared to permanent magnet tips.

Advantageously, the capture device 100 is configured to generate in a portion of the microchannel 21 a magnetic field intensity comprised between 100 mT and 10000 mT, preferably between 100 mT and 500 mT, or between 500 mT and 1000 mT, or between 1000 mT and 10000 mT, more preferably between 1000 mT and 5000 mT, or between 5000 mT and 10000 mT and a gradient, in particular along the longitudinal axis of the microchannel 21, comprised between 10 T/m and 10000 T/m, preferably between 10 T/m and 100 T/m, or between 100 T/m and 500 T/m, or between 500 T/m and 1000 T/m, or between 1000 T/m and 5000 T/m or between 5000 T/m and 10000 T/m.

### Actuator 50a, 50b

The at least one actuator 50a, 50b is preferably a linear actuator configured to move the magnetic element 101 along the Y direction. The at least one actuator 50a, 50b may be a screw-driven linear actuator with a threaded rod that rotates, thus moving a nut along the thread, causing linear motion. Alternatively, it may be a belt-driven linear actuator that uses a belt that is driven by a motor to create linear motion. As another example, it may be a rack and pinion linear actuator that uses a gear (the pinion) that meshes with a rack (a flat bar with teeth) to create the linear motion. It may also be a pneumatic linear actuator that uses compressed air to create linear motion. The air is typically controlled by a valve that opens and closes to allow the air to move a piston back and forth. Alternatively, it may be a hydraulic linear actuator that uses a fluid (typically oil) to create linear motion. The fluid is controlled by a valve that opens and closes to allow the fluid to move a piston back and forth. Moreover, it may be a piezoelectric linear actuator that uses a piezoelectric element to create linear motion. When an electric voltage is applied to the element, it changes shape, causing linear motion. Lastly, it may be an electro-mechanical linear actuator that uses a combination of electric and mechanical components to create linear motion. The most common type is the stepper motor-driven linear actuator.

Typically, the at least one actuator 50a, 50b comprises a movable element that is moved along the Y direction, such a piston rod 51 as illustrated in FIG. 3 or a nut on which the magnetic element 100 is attached to, by either a screw, an adhesive, a weld, a rivet, a bolt, a clamp or a combination thereof. The movable element may be configured to move with respect to a stationary element. Such stationary element may be as a hollow cylinder or a housing 52 such as illustrated in FIG. 3. In one specific embodiment, the magnet 12 has a first surface attached to the piston rod 51, for example, by means of a threaded connection, while an attachment surface of the magnetizable tip 11 is in direct and permanent contact with a second surface of the magnet 12 and attached to it for example by means of an adhesive, magnetic forces or any other means. The second surface of the magnet 12 has at least a same contour and same dimensions as that of the attachment surface of the magnetizable tip 11. In another embodiment, the magnet 12 is attached to the piston rod 51 by means of a press fit or a shrink fit, while the magnetizable tip 11 is attached to the magnet by means of an adhesive or a mechanical fastener. The specific method of attachment may depend on the particular materials used for the actuator and the magnetic element, as well as the desired strength and durability of the connection. Attachment of the magnetizable tip to the magnet enables a better control of the magnetic field when the movable element translate the magnetic element from a close to a distant position and from a distant to a close position. More precisely, it eliminates the magnetophoretic force in the capillary by the recoil of the magnet. Another advantage is that the force amplitude of the magnetic field can be modulated with the adjustment of the distance between the tip and the microchannel.

The at least one actuator 50a, 50b should be able to move the magnetic element 100 at a controlled and consistent speed. The speed will depend on the specific application and requirements of the system 1000. Preferably, the speed range of displacement of the magnetic element 100 is comprised between 1 mm/s and 20 mm/s, preferably between 2 mm/s and 10 mm/s, more preferably between 4 mm/s and 5 mm/s, with a more preferred range of 4.5 mm/s to 5 mm/s.

The length along which the magnetic element 100 may be displaced depends on the design of the microfluidic system 1000. Preferably, the piston stroke is comprised between 8 and 12 mm. The intended displacement may however be comprised between 0 mm and 7 mm, preferably between 0 mm and 6.4 mm. Advantageously, the at least one actuator 50a, 50b is chosen for its micrometer precision, repeatability, and durability. The at least one actuator 50a, 50b should be able to move the magnetic element to the desired position with high precision and accuracy, and should be able to do so repeatedly over many cycles without significant wear or degradation.

For instance, the at least one actuator 50a, 50b may have a repeatability of ±0.1 mm, a maximum speed of 25 mm/s, a maximum force of 22N, a back drive force of 12N and a mechanical backlash of 0.2 mm.

Several actuators 50a, 50b may be used to move the magnetic element 101 in a precise and controlled manner. The positioning and coordination of the at least one actuator 50a, 50b can be achieved using a control system and a frame to maintain the at least one actuator 50a, 50b together on a plane, control alignment, equilibrium and simultaneity of the actuators 50a, 50b.

### Micro Channel 21

The term microchannel 21 designates any tubular like container or duct, e.g. rigid or flexible tube. Microchannels 21 according to the invention are preferably unidimensional, e.g. they have a width, a thickness and length, and the length is much larger, at least 10 times, and often 100 times or more, larger than said width and thickness.

Microchannels 21 according to the invention are advantageously cylindrical or parallelepipedal, but they may also have more complex shapes, involving wedges, bulges, recesses, microstructures on their walls, or any features that can be interesting in microfluidics.

As a general feature, microchannels 21 of the invention are of submillimeter section, i.e. they have either a cross section smaller than 1 mm² on at least a portion of their length, in particular on at least the portion of their length which faces the magnetic activable element, in particular on at least 50% of their length, or at least one cross sectional dimension smaller than 500 μm.

In different preferred embodiments, the cross section of the microchannels 21 according to the invention is comprised between 100 μm² and 5 mm², preferably between 500 μm² and 4 μm², yet preferably between 10 000 μm² and 1 mm².

The microfluidic systems 1000 according to the invention comprises at least one microchannel 21 and may comprise several microchannels 21-23 such as illustrated in FIG. 2. The microchannels 21-23 may be distant of 0.5 to 2 cm. In some other embodiments, the microchannels 21-23 may be disposed with interchannel distances comprised between 100 μm and 0.5 cm. Said microchannels 21-23 can be fully linear, or branched into a network. Microchannels 21-23 may comprise branchings such as side branchings, or cross branchings. Preferably, the branching areas are located along the microchannel 21-23 in areas distant from the areas facing the activable magnetic elements.

A microchannel 21-23 as defined in the invention may advantageously be prepared by lithography or “soft lithography” methods.

The system 1000 of the invention also comprises means for generating droplets in the micro channel including a pump 30.

### Pump 30

The pump 30 may be connected to one end or both ends of the microchannel 21. Advantageously, the pump 30 is connected to the upper end 22 of the microchannel 21, while the lower end 23 of the microchannel 21 can be inserted into a fluid reservoir to pump.

the pump 30 may be a push-pull pump configured to inject and aspirate fluid in and out of the at least one microchannel 21.

The pump 30 may include a pressure controller and/or a flow controller that may be connected to an external pressure source configured to deliver a pressure up to 1 bar. Advantageously, the pump 30 includes a pressure and/or flow sensor configured to measure the pressure applied inside the at least one microchannel 21. The pressure sensor and/or flow sensor allows to implement a pressure and/or flow regulation. The flow controller may be able to regulate flow within 40 ms with a 0.005 % stability.

Advantageously, the pump 30 may communicate with a processor comprising a human-man interface, such as a tablet or a computer. A pressure and/or flow value may be requested by a used through the human-man interface. The pump 30 may be configured to send the pressure and/or flow value measured by the pressure and/or flow sensor to the processor. The processor is then configured to control the pressure and/or flow controller to reach the requested pressure and/or flow.

### Droplets Generation

The system 1000 may comprise means for forming droplets 24 in the at least one microchannel 21 based on at least two immiscible fluids. Various means to create in the microchannel 21 a sequence of droplets 24 are known in the art. They can for instance involve flow focusing devices, T-junctions, or two-phase micropipetting, or a combination thereof.

Thanks to this and combined to the globally unidimensional nature of the microchannel, the invention may allow to transport a multiplicity of samples or reagents, in the form of droplets, by a simple flow or pressure of the surrounding fluid.

The first fluid 33 may be an organic phase comprising oil chosen among fluorinated oil, silicon oil, vegetal oil, mineral oil, hydrocarbon oil and surfactant such as PEG-di-Krytox fluorinated surfactant, perfluoro-octanol, perfluorodecanol, perfluoropolyether (PFPE) derivates including PFPE-PEG triblock copolymers, span 80, Abil EM90, monolein, oleic acid, n-butanol. The second fluid 32 may be an aqueous phase comprising at least one among a cell culture medium, a drug solution, an antibody solution, a cell suspension, a suspension of phase (phospholipid, Triton-X-100, SDS, Pluronic, Tween 20/80).

The size of the droplets 24 can be very variable, ranging from 1 pL to 2 L. However, the invention may advantageously allow the obtaining of droplets in ranges of size not easily available in prior art, in particular between 10 pL and 500 nL, in particular between 10 pL and 100 pL, between 100 pL and 1 nL, between 1 nL and 10 nL, between 10 nL and 100 nL, or between 100 nL and 500 nL.

### Magnetic Particles

The magnetic particles 31 are preferably superparamagnetic. The size of the magnetic particles 31 may be very diverse depending on the application. By size of a magnetic particle 31, it is meant the greatest dimension of said magnetic particle 31. In a preferred embodiment, the magnetic particles 31 have an average size comprised between 0.2 μm and 10 μm, and preferably between 0.5 μm and 5 μm. The average size of a set of magnetic particles 31 is, unless otherwise specified, the granulometric statistic size at D50.

In another embodiment, the magnetic particles 31 may have different sizes. For instance, a first set of magnetic particles 31 with an average size comprised between 1 μm and 5 μm, and a second set of magnetic particles 31 mixed with the first set, with a greater average size, preferably between 10 μm and 50 μm, or between 50 μm and 100 μm, or between 100 μm and 200 μm, or between 200 μm and 500 μm.

The magnetic particles 31 may be functionalized to attach with ligands such as chemical components, drugs, nucleic acids, combinations of nucleic acids and enzymes, such as mixtures used for DNA amplification, antibodies, fluorescent moieties, luminescent moieties, dyes, nanoparticles, gold nanoparticles, quantum dots, DNA intercalating dyes, aptamers, or any types of species putatively able to affect the metabolism of cells, or the properties of colloidal objects according to the invention, in particular their optical properties.

### Method 200

The microfluidic system 1000 may be used to implement a method including several steps illustrated in FIGS. 4 to 9.

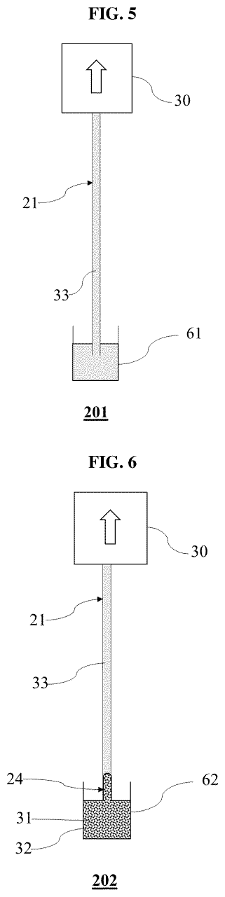

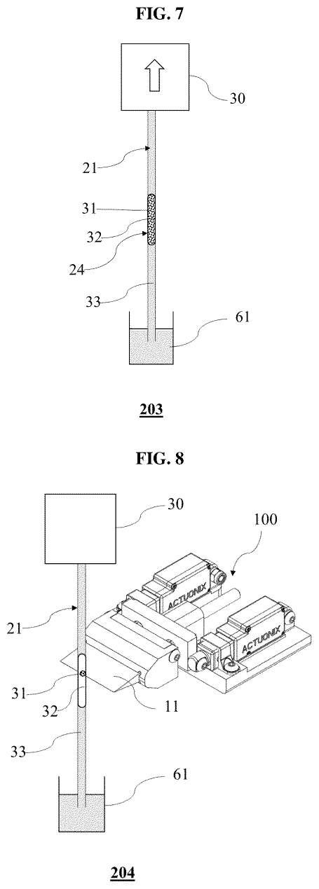

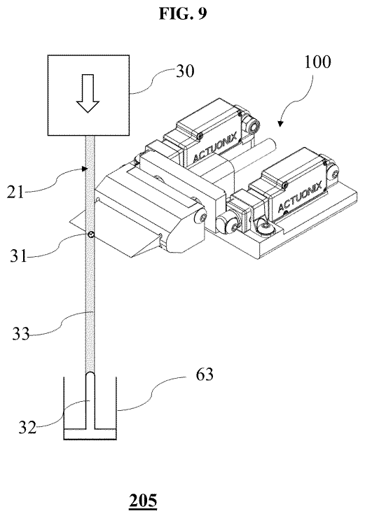

As illustrated in FIG. 5, the first step 201 is the filling of the microchannel 21 with a first fluid 33, that may for instance be an organic phase. The microchannel 21 may be filled using the pump 30, set in aspiration mode, that is configured to pump fluid from a first reservoir 61 of the first fluid 33. Once the microchannel 21 filled, the first reservoir 61 may be switched, in a second step 202 illustrated in FIG. 6, to a second reservoir 62 comprising a second fluid 32, that may for instance be an aqueous phase comprising magnetic particles 31. A droplet 24 of the second fluid 32 may be pumped, in a third step 203 illustrated in FIG. 7, into the microchannel 21. Pumping may be stopped in the fourth step 204 illustrated in FIG. 8 and the capture device 100 may be switched to the first position, wherein the piston rods of the capture device 100 are extended and the tip 11 is put in contact with the microchannel 21. The magnetic particles 31 are therefore subjected to the magnetic field emitted by the tip 11 and aggregate against the microchannel 21 wall where the tip 11 is localized. The magnetic field is stronger than the flow inside the microchannel 21, which is why it is possible, in a fifth step 205 illustrated in FIG. 9, to pump out, toward a third reservoir 63, the droplet 24 of second fluid 32 that does not contain magnetic particles anymore. In a further step, not illustrated in the figures, it may be possible to send a second droplet of a third fluid to retrieve the magnetic particles 31.

According to the invention, the reservoirs 61-63 may be individual reservoirs or comprised in a multi-wells plate.

1. A microfluidic system comprising:
at least one microchannel,
a pump connected to the at least one microchannel and configured for driving at least one fluid comprising at least one magnetic particle alongside said microchannel,
at least one capture device comprising:
a magnetic element configured to produce a magnetic field with a fixed range of action, said magnetic element comprising a magnetizable tip and a magnet, wherein the magnetizable tip comprises a soft magnetic material and the magnet is a permanent magnet configured to generate a persistent magnetic field
at least one actuator, configured for moving together the magnetizable tip and the magnet of the magnetic element relative to the microchannel,
the capture device being configured to adopt two positions:
a first position wherein the magnetizable tip is close to the microchannel, said microchannel being comprised in the range of action of the magnetic field of the magnetic element, the capture device being configured to apply the magnetic field to the at least one magnetic particle present in the at least one microchannel to capture the at least one magnetic particle, and
a second position wherein the magnetizable tip is distant from the at least one microchannel, said microchannel being outside of the range of action of the magnetic field of the magnetic element, so that the at least one magnetic particle present in the microchannel are free to move in the at least one fluid.

2. The microfluidic system according to claim 1, wherein the actuator, is configured to move the magnetic element relative to the microchannel using a translation motion transversal to an axis of the at least one microchannel.

3. The microfluidic system according to claim 1, wherein the at least one actuator comprises a housing and a piston rod inside the housing, said piston rod being configured to be moved along a length of the housing, and wherein the magnetic element is attached to the piston rod.

4. The microfluidic system according to claim 3, wherein the magnet comprises a first surface and a second surface opposed to the first surface, the first surface being attached to the piston rod and the second surface being attached to an attachment surface of the magnetizable tip.

5. The microfluidic system according to claim 4, wherein a contour of the second surface of the magnet is at least as large as a contour of the attachment surface of the magnetizable tip.

6. The microfluidic system according to claim 3, wherein the system comprises two parallel actuators including a first actuator and a second actuator, the magnetic element being attached to a first piston rod of the first actuator and to a second piston rod of the second actuator.

7. The microfluidic system according to claim 1, wherein in the first position, the tip is in contact with the at least one microchannel.

8. The microfluidic system according to claim 1, wherein the magnetic field generated at the magnetizable tip has a value comprised between 100 mT and 10000 mT and a gradient comprised between 100 T/m and 10000 T/m.

9. The microfluidic system according to claim 8, wherein the at least one actuator is configured to move the magnetic element at a speed comprised between 1 mm/s and 20 mm/s.

10. The microfluidic system according to claim 8, wherein in the second position, the tip is located within a distance comprised between 5.5 mm and 7 mm from the at least one microchannel.

11. A method of extracting at least one magnetic particle from at least one droplet of at least one fluid flowing in at least one microchannel, said method using a system according to claim 1, said method comprising the step of:
pumping inside said microchannel the at least one fluid comprising at least one magnetic particle, and
switching the capture device to the first position and capturing the at least one magnetic particle.

12. The method according to claim 11, wherein the method further comprises:
pumping inside said microchannel a first fluid,
pumping inside said microchannel at least one droplet of a second fluid, said second fluid being immiscible with the first fluid, said second fluid comprising the at least one magnetic particle,
switching the capture device to the first position and capturing the at least one magnetic particle present in the at least one droplet of second fluid, and pumping outside said microchannel the at least one droplet of the second fluid.
